(19) United States
(12) Patent Application Publication
(10) Pub. No.: US 2010/0325229 A1
(43) Pub. Date: Dec. 23, 2010

(54) Methods and Apparatus for Exchange of Electronic Communications

(75) Inventor: Timothy D. Kelley, Erie, CO (US)

Correspondence Address: SANTANGELO LAW OFFICES, P.C., 125 SOUTH HOWES, THIRD FLOOR, FORT COLLINS, CO, 80521, US

(73) Assignee: VERBAL WORLD, INC., Boulder, CO (US)

(21) Appl. No.: 12/866,452

(22) PCT Filed: Feb. 9, 2009
(86) PCT No.: PCT/US2009/033580

§ 371 Date: Aug. 5, 2010

Related U.S. Application Data
(60) Provisional application No. 61/027,303, filed on Feb. 8, 2008.
(60) Provisional application No. 61/050,960, filed on May 6, 2008.
(60) Provisional application No. 61/050,953, filed on May 6, 2008.

(51) Int. Cl. G06F 15/16

(52) U.S. Cl. 709/206

(57) ABSTRACT

Methods and apparatus may provide enhanced functionality for the exchange of electronic communications. A group message response content processor (8) may permit automatic group processing of multiple responses to an electronic communication. Automatic collation of multiple responses may be achieved with an individual recipient response data collation module (17), automatic ordering of multiple responses may be achieved with an individual recipient response data ordering module (23), and meta-processing of group processed individual recipient response data may be achieved with a grouped response information meta-processor module (25). An incoming electronic communications content processor (30) may permit automatic review of electronic communications for relevant electronic identification data. Identification data of electronic communications may be altered by a relevant electronic identification data alteration processor module (32). Processed electronic communications may be received and transmitted over on-net and off-net communications networks with enhanced functionalities.

### CROSS REFERENCE TO RELATED APPLICATIONS

This application is an International Application claiming priority to and the benefit of U.S. Provisional Application No. 61/027,303, filed Feb. 8, 2008, U.S. Provisional Application No. 61/050,960, filed May 6, 2008, and U.S. Provisional Application No. 61/050,953, filed May 6, 2008, each hereby incorporated by reference.

### TECHNICAL FIELD

Generally, the inventive technology relates to the exchange of electronic communications. More particularly, the inventive technology involves novel methods and apparatus for the automated identification of electronic communications and automated processing of groups of electronic communications. The inventive technology may be particularly suited for exchange of electronic communications over various types of communications networks.

### BACKGROUND

Private branch exchanges, in various contexts, may be telephone exchanges or systems of similar functionality that serve a smaller subset of users than the overall PSTN. For example, private branch exchanges may be used by businesses, governments, and other types of organizations to provide communications capabilities to their members. In particular, a private branch exchange may provide both internal connections, such as telephone extensions for individuals working within an organization, as well as external connections, such as telephone trunk lines to the PSTN. Private branch exchanges may permit cost savings, for example perhaps by reducing charges for telephone service by switching calls internally within the exchange, and may provide services perhaps not available on the PSTN, such as multiple party messaging and extension dialing. The technology for private branch exchanges also may have evolved over time, for example perhaps to include utilization of packet switching technology over data networks such as the Internet. Moreover, business models for private branch exchanges similarly may have evolved, for example perhaps to include the hosting and management of private branch exchanges by telephone service providers themselves, so that customers may contract for the service.

However, conventional private branch exchange systems may entail a number of drawbacks. Setting up a private branch exchange may involve any of contracting with a service provider, purchasing expensive on-site equipment, or allocating in-house personnel to manage the system or perhaps obtaining an outside service to manage the system. Management tasks such as configuring the exchange or updating exchange settings, for example to keep up with business operations or the like, may require specialized expertise which may not be readily available in-house. Involvement of outside service providers of course may incur timeliness of scheduling issues and service fees. As of this writing, service fees for private branch exchange service may be perhaps hundreds or perhaps thousands of dollars per month, perhaps even not including specialized expenses for installation, maintenance, management, and the like.

In addition, conventional private branch exchange systems may have, at least to some degree, limited functionalities. For example, utilization of the features of the exchange effectively may require specialized equipment or services specific to that exchange. Access to exchange features from remote locations may be limited, for example when individuals may be traveling, working at home, or the like. Certain exchange features perhaps may be utilized only by certain kinds of telephones, for example perhaps due to equipment compatibility issues or service provider restrictions. Using stock telephones with certain exchange features may be problematic, such as sending a message to multiple recipients, searching contacts by both first and last name or other multiple parameters, recording multiple screening questions for call screening or voicemail, and the like.

Moreover, on-net calling may be becoming a viable alternative to making long-distance telephone calls over the PSTN. When using the PSTN, long-distance calls generally are routed through switches to get from the source exchange to the destination exchange. For example, a call may be routed from the source telephone through the lines of the local exchange to the local exchange's switch, which may then switch the call to the lines of the long-distance carrier servicing the source telephone. The call then may be delivered by the lines of the long-distance carrier to the local switch of the destination exchange, which may switch the call to the destination telephone using the local lines of the destination exchange.

As the call is routed over the PSTN, fees may accrue and be billed to the source telephone, for example for switching the call and carrying the call over lines belonging to various companies. While the call is in transit, it may be identified and tracked by automatic number identification (ANI) data associated with the call. ANI, originally developed by telephone companies for billing purposes, generally involves including a series of digits with the call, either analog or digital, that disclose the identity of the calling number. As a result, fees accrued as the call transits various lines and exchanges may be tracked and billed to the source telephone.

By way of contrast, on-net calling may allow for long-distance calling without accruing long-distance fees, because calls may be routed through alternatives to the PSTN, such as the Internet. Because information routed through non-PSTN networks may avoid the switches and lines of the PSTN, no fees may be accrued. Accordingly, when a call is placed between on-net telephones of a non-PSTN network, the call may cost substantially less or may even be free no matter the physical distance between the telephones.

However, on-net calling often requires the use of specialized equipment. For example, the data transfer protocols of the non-PSTN network may be different than that of the PSTN. The Internet, for example, generally may operate using packet-switching protocols. Accordingly, regular telephones often may not be compatible with non-PSTN networks, and users wishing to take advantage of on-net calling may be required to invest in specialized equipment, such as voice over Internet Protocol (VoIP) telephones or routers. Moreover, the cost savings of on-net calling may be fully realized only when calls are placed between on-net telephones. Calls made from an on-net telephone to an off-net telephone still may be subject to at least some long-distance fees for portions of the call transiting the PSTN, for example as wherein ANI information from the source on-net telephone may be identified by the local switch of the off-net destination telephone, and fees assessed accordingly. Additionally, conventional on-net networks may be limited in their system architectures. For example, conventional on-net networks may not utilize the system architecture of an enhanced communications exchange. Accordingly, conventional on-net networks may lack the benefits of such enhanced communications exchange functionalities.

The foregoing problems related to conventional private branch exchange functionality and conventional telephone calling may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

### SUMMARY DISCLOSURE OF THE INVENTION

The inventive technology relates to methods and apparatus for the exchange of electronic communications and in embodiments may include the following features: techniques for automatically reviewing the data content of multiple electronic communications; techniques for automatically group processing the data content of multiple electronic communications; techniques for automatically identifying relevant identification data of electronic communications; techniques for automatically altering relevant identification data of electronic communications; and techniques for configuring identification data of electronic communications for optimal transmission over on-net and off-net networks. Accordingly, the objects of the methods and apparatus for the exchange of electronic communications described herein address each of the foregoing in a practical manner. Naturally, further objects of the inventive technology will become apparent from the description and drawings below.

### BRIEF DESCRIPTION OF THE DRAWINGS

FIG. 1 is a schematic view of an electronic communications exchange system having a group message content processor (8) in one embodiment.

FIG. 2 is a schematic view of an electronic communications exchange system having an incoming electronic communications content processor (30) in one embodiment.

FIG. 3 is a schematic view of an electronic communications exchange system having an automated central hub (1) in one embodiment.

### MODES FOR CARRYING OUT THE INVENTION

As mentioned earlier, the present inventive technology includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

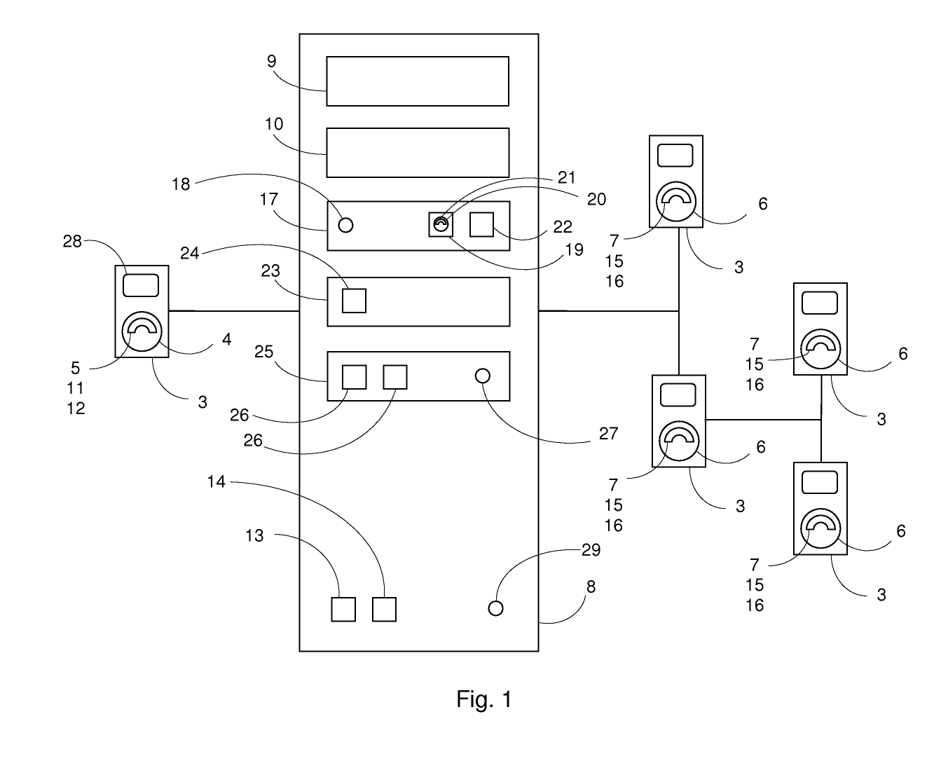

In various embodiments, the inventive technology may utilize an enhanced communications exchange, as shown for certain particular embodiments in FIGS. 1-3. The enhanced communications exchange may provide some or all of the capabilities of a conventional local exchange, conventional private branch exchange, or the like, and even may include enhanced exchange functionalities perhaps as described elsewhere herein.

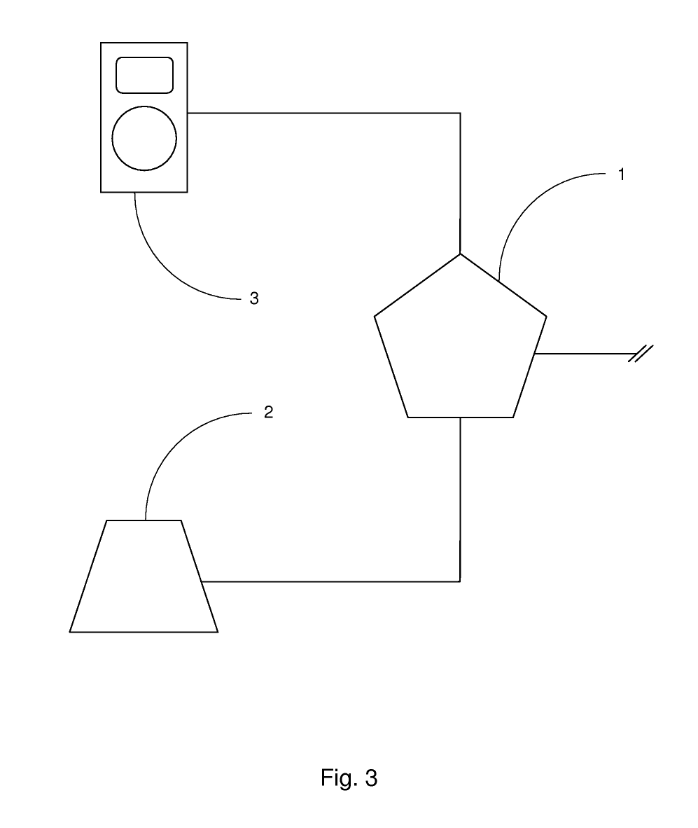

In some embodiments, an enhanced communications exchange may utilize an automated central hub (1), shown for example in one embodiment in FIG. 3, to execute exchange functions, such as call forwarding, extension dialing, or perhaps other conventional or enhanced exchange functionalities. In this manner, the hub (1) may receive and handle inputs from communications devices (3), such as telephones, landlines, cell phones, smart phones, personal digital assistants, VoIP devices, computers, desktops, laptops, and the like. For example, in basic embodiments, the hub (1) may serve to complete simple user to user telephone calls. Moreover, the functionalities of the hub (1) may be configured, managed, or otherwise set by using an access portal (2) networked to the hub (1). For example, in some embodiments an access portal (2) may be a remotely located computer connected to the hub (1) via an Internet connection and having a Web-based interface. Any device suitable for carrying out in an automated fashion the functionalities as described herein may be appropriate for use as a hub (1). For example, in some embodiments a hub (1) may be a computing device having suitable hardware components for connecting with the appropriate communications hardware, such as telephone lines, coaxial cable lines, fiber optic lines, Internet lines, wireless networks, or the like, and suitable software to execute the appropriate exchange functionalities of the hub (1). In various embodiments, individual users desiring to use the functionalities of the hub (1) may be provided with an access number, which may be a telephone number or other communications device code the user may utilize to establish a connection with the hub (1). The access number may provide an interface through which the user may configure hub (1) functionalities in some embodiments. Moreover, the access number may provide tracking information by which the hub (1) can track the user's information, for example in an account containing billing information, saved settings of the user, and the like.

Additionally, in certain embodiments all or some of a group message response content processor (8), an individual recipient response data review module (9), and a group message response data processor module (10) may comprise all or part of an automated central hub (1). Similarly, in some embodiments all or part of an automated central hub (1) may comprise all or some of an incoming electronic communications content processor (30), a relevant electronic origination identification data processor module (31), a relevant electronic identification data alteration processor module (32), and an outgoing electronic communications router (33).

An access portal (2) in various embodiments, such as shown for one embodiment in FIG. 3, may provide an interface for accessing the hub (1), for example to configure, manage, or otherwise set the functionalities of the hub (1). For example, in basic embodiments the access portal (2) may be used to change extension calling features controlled by the hub (1), such as adding or deleting extensions, changing extension numbers, and the like. Any device suitable for accessing the hub (1) as described herein may be appropriate for use as an access portal (2), including for example direct hardware controls or software interfaces on the hub (1) itself, or perhaps even hardware controls or software interfaces that are remotely located from the hub (1) and connected thereto by suitable connections such as via the Internet. In some embodiments, the access portal (2) may be user-accessible, for example perhaps by general consumers, and may not require specially trained personnel to operate. Moreover, the interface for an access portal (2) perhaps may be cross-platform, for example perhaps usable on various types of devices and operating systems, such as perhaps a Web-based interface accessible through a Web page on the World Wide Web. In some embodiments, access portals (2) may include desktop computers, laptop computers, or in some instances even certain kinds of communications devices (3) connected to the hub via the Internet or a similar networking technology.

Utilizing communications devices (3) in various embodiments, such as shown in exemplary embodiments in FIGS. 1-3, perhaps may involve electronically transmitting or receiving information from at least one such device to at least another such device. Examples of communications devices (3) may include telephones, landlines, cell phones, smart phones, personal digital assistants, VoIP devices, computers, desktops, laptops, and the like. Communications devices (3) also may be attached communications devices (3). Attaching communications devices (3) to one another may involve automatically forwarding electronic communications received on one communications device (3) to one or more additional communications devices (3).

In some embodiments, an enhanced communications exchange, such as shown in exemplary embodiments in FIGS. 1-3, may be utilized for the transmission and reception of electronic communications, for example perhaps by routing the information through an automated central hub (1) as shown for example in FIG. 3. Where an electronic communication is routed through an automated central hub (1), the nature of the interaction between a communications device (3) and the hub (1) may be as appropriate. For example, telephony embodiments may employ dual tone multi-frequency protocols to permit interaction between the communications device (3) and the hub (1), for example as where a cell phone user may punch the keypad of the cell phone to control the hub's (1) functionality. Naturally, when the communication is routed through the hub (1), the exchange functions of the hub (1) may be utilized. For example, a cell phone call routed through the hub (1) to the telephone number of a recipient may further be routed by the hub (1) to additional attached communications devices (3) of the recipient, such as home, business, or cell phone numbers. Moreover, routing through the hub (1) of course need only occur at one point in the communications path. For example, some or even a majority of the communication could travel over existing networks such as the PSTN, the Internet, or similar networks.

Various embodiments may involve exchanging electronic communications, shown for example in exemplary embodiments in FIGS. 1-3. The exchange of electronic communications may involve the transmission of information using electronic technology. Information constituting an electronic communication of course may be in electronic form, but otherwise may encompass any information capable of electronic transmission. For example, electronic communications may include voice communications, text communications, email communications, audio communications, visual communications, and the like. Electronic communications even may include convertible format communications, such as text-to-voice communications or voice-to-text communications, wherein the conversion from text-to-voice or voice-to-text may be done by suitable speech recognition software or the like. An electronic communication also may be in any suitable format, such as an analog communication, a digital communication, a packet-switched communication, an Internet Protocol communication, or the like. In various embodiments, the exchange of electronic communications may take place over an enhanced communications exchange.

Embodiments may involve exchanging electronic communications over a communications network. Any suitable network capable of carrying electronic communications from one communications device (3) to another may be utilized as a communications network in various embodiments. Examples of communications networks may include all or some portion of a PSTN, all or some portion of a data network, all or some portion of the Internet, all or some portion of a VoIP network, all or some portion of a wireless network, all or some portion of a satellite network, and the like.

Of course, an automated central hub (1), access portals (2), and communications devices (3) described herein need not be located in proximity to one another. Indeed, significant advantage may be realized when these devices are remotely located. For example, embodiments may involve locating an automated central hub (1) at a convenient location, such as perhaps a service provider facility. Customers of the service provider located in geographically disparate locations, such as corporate branch offices in different cities or countries, may be able to configure the hub (1) for their individualized needs by using access portals (2) at their locations. Ultimately, members of the organization may be able to use their communications devices (3) to contact one another, all the while gaining the functionalities that have been set at the hub (1).

A variety of functionalities may be utilized in conjunction with the enhanced communications exchange described herein, shown in exemplary embodiments in FIGS. 1-3. In various embodiments, the functionalities may be, but may not necessarily be required to be, implemented through an automated central hub (1), configured via an access portal (2), and applied to communications routed through the hub (1).

Embodiments may involve a naming functionality to create a name association for incoming communications. Such an association may involve automatically recognizing some attribute of an incoming communication and associating the communication to a predefined name based on a predefined relationship. For example, in telephony embodiments, including perhaps voice-over-Internet-protocol embodiments, incoming telephone calls from known telephone numbers may be named as appropriate (such as “office call”, “personal call”, “home business call”, “customer service call”, or the like). In this manner, the recipient of the communication may be able to preview the name of the communication prior to receiving it. The options for configuration may be any as may be suitable, including perhaps user creating any suitable name using any suitable combinations of characters, creating multiple names for given incoming communications, grouping multiple communications under a single name, associating names to contact lists or elements thereof in any suitable combination, and so forth.

Embodiments may include a greeting functionality to create one or more custom greetings for a given communications device (3). For example, in telephony embodiments, including perhaps voice-over-Internet-protocol embodiments, a user may type a desired greeting into a Web-based interface of an access portal (2). The greetings may be for personal use (such as “Hello. You have reached John. Please use my custom menu to find me.”), business use (such as “Welcome to company XYZ. Please hold while you are directed to our company menu.”), or any use as may be appropriate. The typewritten text may be converted to an audio file by the central hub (1) using a suitable text-to-speech protocol, perhaps resulting in a speech greeting. Incoming calls to the given telephone number may then receive the speech greeting.

Embodiments may involve a functionality for creating customized audio menus for given communications devices (3). For example, in telephony embodiments, including perhaps voice-over-Internet-protocol embodiments, a Web-based interface of an access portal (2) may allow a user to set up an audio menu that is played when an incoming call is received at a given telephone number. The menu options may be configured for any suitable function and in any given order. For example, menu options might include connecting directly to the call recipient by further dialing any of the recipient's telephone numbers (such as “Press 1 to locate Mr. Smith.”), connecting to the call recipient's voicemail including via any voicemail greeting or voicemail screening questions (such as “Press 2 to go directly to Mr. Smith's voicemail service.”), or permitting the user to have another telephone number dialed through the menu options (such as “Press 3 for customer service, or press 4 for sales.”).

Embodiments may involve a functionality for creating customized screening questions for given communications devices (3). For example, in telephony embodiments, including perhaps voice-over-Internet-protocol embodiments, a Web-based interface of an access portal (2) may allow a user to create screening questions to be played when an incoming call is received at a given telephone number. The screening questions perhaps may be chosen from a preset list, or perhaps may be typewritten into the interface and converted to an audio file by appropriate text-to-speech software. As the incoming caller answers the screening questions, the answers may be previewed by the user to assist in taking or declining the incoming call. If a declined incoming call is sent to the user's voicemail, the caller's answers to the screening questions may be appended to the voicemail for further review by the user. Naturally, the screening questions may be of any kind and any number as may be useful to the user (such as “Please give me your name,” “What is the subject of this call”, “Is this call urgent”, and the like) and may be edited, changed, updated, and the like as appropriate, all perhaps via an access portal (2) to configure the hub (1). Moreover, embodiments may permit a user to select one set of screening questions for a communications device (3) and another set of screening questions for a messaging system, perhaps as described elsewhere herein. For example, a user may select screening questions to elicit certain kinds of information for live calls to a cell phone, but select different screening questions if the live call is sent to voicemail. In addition, where multiple users utilize the communications screening device functionality, for example in the case of multiple extensions in an office environment, each user may be able to select his or her own particular set of screening questions.

Embodiments may involve a functionality for connecting to attached communications devices (3). For example, in telephony embodiments, including perhaps voice-over-Internet-protocol embodiments, a Web-based interface of an access portal (2) may allow a user to specify that incoming calls to a given telephone number be further routed to additional telephone numbers. Any number of additional telephone numbers for any types of telephones may be connected in any order suitable for the user, including perhaps via sequential dialing or concurrent dialing (such as a home telephone number, a business telephone number, a cellular telephone number, a hotel room telephone number, a vacation home telephone number, and the like).

Embodiments may include a message notification functionality. Users may be notified on all of their communications devices (3) of messages coming in to any one of their communications devices (3). For example, in telephony embodiments, including perhaps voice-over-Internet-protocol embodiments, a Web-based interface of an access portal (2) may allow a user to enter any number of telephone numbers or even email addresses as may be desired. Incoming voice messages to a given telephone number for the user may be received as appropriate. The automated central hub (1) may then generate a text message that is forwarded to all of the specified telephone numbers and email addresses, informing the user of the received voice message. The text message may include additional information, such as the telephone number of the incoming received voice message, the number of new messages, the number of saved messages, and the like.

Embodiments may include a communications logging functionality. Inbound and outbound communications, in some embodiments such as may be routed through an automated central hub (1), may be logged and the data may be made available to a user, such as through an access portal (2). The options for logging data may be any as may be suitable for a given use, and of course may be configured through the access portal (2). For example, in telephony embodiments, including perhaps voice-over-Internet-protocol embodiments, a Web-based interface of an access portal (2) may allow users to see, over the Internet, details such as incoming telephone numbers, outgoing telephone numbers, time stamps, call durations, and the like. Moreover, embodiments may involve suitable search functionality, again perhaps over the Internet via a Web-based interface of an access portal (2), of the logged data. Search criteria may be any as may be appropriate, for example area codes, time stamps, durations, date ranges, and the like.

Embodiments may include a contacts list creation functionality. Access portals (2) may be used to create contacts lists from scratch or from contacts lists imported from other sources. Importing a contacts list into the access portal (2) may be accomplished in any suitable manner. For example, a software functionality in various embodiments may permit a user to import a comma separated values file or other downloaded file, as from a Microsoft Outlook contacts file, Microsoft Excel spreadsheet file, or similar software application. Moreover, contacts lists may be edited or otherwise configured by users in any suitable manner through the access portal (2). For example, groups of contacts may be created by organizing or subdividing contacts lists according to any suitable criteria, such as contacts for text messaging, contacts for dual tone multi-frequency calling, personal contacts, business contacts, geographic location of contacts, and the like. Contacts lists and groups created through the access portal (2) in this manner then may be stored on an automated central hub (1), and may be accessed and utilized by any communications device (3) networked to the hub (1). For example, a user perhaps need not store contacts on a given communications device (3), but rather perhaps simply may connect to the hub (1) with the communications device (3) and utilize the contacts lists or groups stored there. In this manner, the need to update contacts on all of the user's communications devices (3) may be avoided. The user then may place calls, send text messages, or the like, using his communications device (3) and appropriate contacts lists or groups stored on the hub (1).

Some embodiments may include an access portal (2) group messaging functionality. Messages entered through an access portal (2) may be delivered to one or more communications devices (3) for each of one or more recipients, perhaps with the ability to deliver the message to all recipients either sequentially or concurrently. The recipients' contact information may be as stored in some embodiments on an automated central hub (1), and in various embodiments may be contact lists or groups that the user has previously defined. For example, in telephony embodiments, including perhaps voice-over-Internet-protocol embodiments, a user may type a desired message into a Web-based interface of an access portal (2). In some embodiments, the typewritten message may be delivered as a text message to specified telephone numbers or email message to specified accounts. Embodiments also may include converting the typewritten message to an audio file using an appropriate text-to-speech capability, and delivering an audio message to specified telephone numbers. Moreover, the user may configure delivery options for the message according to any suitable criteria using the access portal (2). For example, the user may specify individual or groups to receive the message, the time of delivery, a title for the message, and the like. In addition, delivery of the message, for example by the hub (1), may be recipient-sensitive, perhaps distinguishing between live recipients and automatic messaging systems. For example, a live person receiving the message may be provided the opportunity to replay the message as appropriate, whereas a voicemail system may be permitted to play any greeting or other entry audio before the message is delivered once, in its entirety, perhaps to avoid truncation by the voicemail system. When delivery options have been configured by the user, the message perhaps may be sent to all intended recipients in a “single key” manner.

Some embodiments may include a dual tone multi-frequency group messaging functionality. Messages may be delivered to one or more communications devices (3) for each of one or more recipients from a dual tone multi-frequency enabled communications device (3), such as a landline, cell phone, personal digital assistant, voice-over-Internet-protocol device, or the like. Messages sent in this manner may avoid the need to use an access portal (2), and instead may be sent directly from a communications device (3), wherein dual tone multi-frequency protocols may be used, such as to interact with an automated central hub (1). For example, in telephony embodiments, including perhaps voice-over-Internet-protocol embodiments, a user may connect to a hub (1) by dialing a telephone number. Using the telephone's keypad to send dual tone multi-frequency signals to the hub (1), the user may access the hub's (2) messaging functionality. For example, the user may record a voice message and specify delivery options, such as specifying contacts lists, groups, or individuals to receive the message, specifying the time of delivery, and the like. When delivery options have been specified, the message perhaps may be sent to all intended recipients in a “single key” manner. Naturally, group messaging in either the access portal (2) or dual tone multi-frequency functionalities may be useful when large numbers of recipients need to be notified of the message, for example when a meeting time is changed or when emergency information needs to be communicated.

With further reference to FIG. 1, embodiments may involve user entering an electronic communication into a communications device (3). The entry of such information by the user of the communications device (3) may be accomplished in any manner by which the communications device (3) may accept the entry of information, such as by voice entry, typed entry, electronic upload of information such as from a USB device or SD card, electronic download of information such as from a computer, or in other such like manners. Accordingly, as shown in FIG. 1, the communications device (3) in various embodiments may be a source communications device (3) with a user input (4) having a group message entry (5). The user input (4) may permit the entry of information by the user into the source communications device (3) as described herein, and the group message entry (5) may provide an interface allowing the user to configure the input information as a group message.

Embodiments may involve user sending the entered electronic communication to a plurality of recipients utilizing the communications device (3), perhaps to a plurality of recipient communications devices (3). User sending the entered electronic communication in this manner may be considered as sending a group message or group messaging the plurality of individual recipients. Sending of the electronic communication by the user of the communications device (3) may be done in any manner by which the communications device (3) may transmit and receive electronic communications. For example, a communications network capable of use by the communications device (3) may be utilized to send the electronic communication. Of course, the plurality of recipients may be any of the user's choosing capable of receiving the user's sent electronic communication, as for example two or more individual recipients each having one or more recipient communications devices (3) of their own. In various embodiments, the plurality of recipients may comprise a large number of recipients wherein it may be advantageous to simultaneously provide each recipient with the user's message, perhaps such as essential service providers in situations where services are disrupted (for example power outages, transportation disruptions, or the like), emergency service providers in emergency situations (for example weather emergencies, medical emergencies, or the like), news media outlets when information must be communicated to the public (for example weather alerts, child abduction emergencies, or the like), or other situations where the ability to communicate a message to a large number of recipients may be advantageous.

In various embodiments, user sending an entered electronic communication to a plurality of recipients may involve specifying group message preferences for the electronic communication. Specifying group message preferences may involve user selecting attributes related to sending the electronic communication that are based on one or more characteristics of the group, such as selecting which members of group should receive the electronic communication, when the electronic communication should be sent to individual members of the group, or any other appropriate group-based characteristics. Group message preferences may be user specified in some embodiments, such as shown in FIG. 1, through a group message preferences interface (11) of a group message entry (7) of the user's source communications device (3).

In some embodiments, sending the electronic communication may be done in a single-key manner, for example where prior preferences may be automatically recalled and a new electronic communication may be sent using the prior preferences, perhaps eliminating the need for the user to specify the preferences again and allowing the user to send the message with as few as a single keystroke. In various embodiments, such as shown in FIG. 1, a single key interface (12) of a group message entry (7) of a user's source communications device (3) may allow the user to configure information input in the communications device (3) in a single-key manner.

Embodiments also may involve user sending the electronic communication to all attached communications devices (3) for any or all individual recipients of the message. An attached communications device delivery subroutine (13), such as shown in FIG. 1, may be utilized in various embodiments to accomplish such sending. Such a subroutine naturally may include hardware, software, or both kinds of components suitable to accomplish such sending, and may be utilized by other processors and modules described herein as needed.

Some embodiments may involve automatically distinguishing a live recipient from an automated messaging service, and delivery of the user's electronic communication may be varied accordingly. For example, where a live recipient is detected, the user's electronic communication may be immediately played back, whereas if an automated messaging service is detected, playback of the user's electronic communication may be delayed until any greeting provided by the automated messaging service is completed. A recipient response detection subroutine (14), such as shown in FIG. 1, may be utilized in various embodiments to accomplish such detection. Such a subroutine naturally may include hardware, software, or both kinds of components suitable to accomplish such detection, and may be utilized by other processors and modules described herein as needed.

Embodiments may involve providing each such individual recipient with at least one response option to the electronic communication. A response option simply may be an option which the individual recipient may exercise to reply to the user who sent the electronic communication in a manner responsive to the content of the sent electronic communication. For example, in some embodiments a response option simply may be a further electronic communication from the individual recipient to the user containing information responsive, at least to some degree, to the user's original message. Providing such a response option may be done in any manner executable by the individual recipient's communications device (3). For example, providing a response option may involve providing options to contact the user by voice, text, email, or the like. Moreover, a recipient communications device (3) in various embodiments, such as shown in FIG. 1, may include a recipient input (6) having a group message response entry (7). The recipient input (6) may permit the entry of information by the individual recipient into the recipient communications device (3), such as described herein, and the group message response entry (7) may provide an interface allowing the recipient to configure the input information to respond to the user's original message.

Various embodiments may include providing each individual recipient with at least one user-predefined response option. The user sending the original electronic communication may select in advance one or more attributes of the response option, and the predefined response option may be included with the electronic communication sent to the individual recipient. Attributes that the user may select may include for example limiting the response to voice responses, text responses, email responses, yes or no answers to questions, or the like. Any attribute of the response capable of user predefinition and executable by the communications devices (3) involved potentially may be utilized a user-predefined response option. Moreover, a user-predefined response option in various embodiments, such as shown in FIG. 1, may be manifested as a predefined group message response entry (15) of a recipient input (6). Such a predefined group message response entry (15) may allow the recipient to configure response information according to a user-predefined response option.

Various embodiments also may include providing each individual recipient with multiple response parameters. A response sent by an individual recipient may reply to information in the original electronic communication sent by the user in multiple ways. Examples of multiple response parameters may include being able to enter multiple items into a list, being able to provide a single response as all of a voice, text, or email communication, being able to respond to any of the original user, other individual recipients of the original message, or new individual recipients of the responding individual recipient's choosing, and the like. Any parameters executable by the communications devices (3) involved potentially may be utilized as multiple response parameters. Moreover, multiple response parameters in various embodiments, such as shown in FIG. 1, may be manifested as a multiple parameter group message response entry (16) of a recipient input (6). Such a multiple parameter group message response entry (16) may allow the recipient to configure response information according to the multiple response parameters.

In various embodiments, such as shown in FIG. 1, individual recipients may respond to the user's original message, for example by entering an electronic communication into a group message response entry (7). Embodiments may include a group message response content processor (8) responsive to one or more group message response entries (7). The group message response content processor (8), for example, may receive group message responses submitted through individual group message response entries (7). A group message response content processor (8) may perform data processing of the content of such group message responses. For example, such data processing may involve transforming some portion or aspect of the content to some degree, such as by actions including sorting content, selecting content, performing an operation on content, running content through an algorithm, or the like. Such data processing of group message responses may involve manipulating the group message response content to create new content, perhaps to generate new information value, perhaps as described herein. Moreover, a group message response content processor (8) in various embodiments may include a user-specified preference input (29). The user-specified preference input (29) may permit the entry of preference information by the user into the group message response content processor (8), perhaps as described herein.

Embodiments may involve automatically reviewing individual recipient response data provided by at least one individual recipient replying to an electronic communication sent by the user. Individual recipient response data simply may be all or some part of the information in a response sent by an individual recipient in reply to the user's original electronic communication. In this manner, recipient response data may be any information provided in response to the user's original message, including for example information such as schedule information, availability information, weather information, alert information, traffic information, emergency information, or any other response information. Reviewing the individual recipient response data may involve an analysis of the data on any suitable basis, such as for the presence or absence of particular information, the identity of the individual who authored the message, the electronic format of the data, and the like, and an automatic review may include such a review wherein all or part of the review is accomplished autonomously and without guidance from a human. Of course, reviewing individual recipient response data provided by at least one individual recipient may include automatically reviewing multiple individual recipient response data provided by multiple individual recipients.

Various embodiments may include an individual recipient response data review module (9) of a group message response content processor (8), such as shown in FIG. 1. Such a module may be a component of the processor dedicated to the review of individual recipient response data. Review of such data may be accomplished perhaps as described herein, and such an individual recipient response data review module (9) in fact may provide for the automated capability for automatically reviewing individual recipient response data in some embodiments.

In some embodiments, reviewing the individual recipient response data may involve automatically identifying user relevant data. Such user relevant data may be information in the response relevant to the user sending the original message, for example such as answers to questions posed in the original communication or information otherwise sought by the user, and identification of such data may make it separately available for group processing. An individual recipient response data review module (9) in such embodiments may be, at least in part, a user relevant data review module. Similarly, some embodiments may include automatically identifying group relevant data. Such group relevant data may be information in the response relevant to the group comprising the plurality of individual recipients receiving the original message, such as a change in scheduling of a group event or the like, and identification of such data again may make it separately available for group processing. An individual recipient response data review module (9) in such embodiments may be, at least in part, a group relevant data review module. Naturally, any relevant data capable of automatic identification from individual recipient response data may be utilized as described herein.

Embodiments may involve automatically group processing said automatically reviewed individual recipient response data. Group processing may involve processing individual recipient response data based on one or more criteria upon which one individual recipient response may relate to another individual recipient response. For example, group processing may be based on the number and identities of individual recipients responding to the user's original message, the content of individual recipient responses such as answering “yes” or “no” to a question posed in the original user's message, the formats that various individual recipient responses may be in, or any other like criterion. In this manner, it can be seen the group processing may be applied to individual recipient response data provided by multiple individual recipients, but it also can be applied to individual recipient response data provided by a single individual recipient. For example, group processing of individual recipient response data provided by a single recipient may involve noting that only one of several recipients replied to the user's original message, or similar kinds of analysis. Moreover, any suitable kind of processing may be applied consistent with the group principles just described, such as data processing, batch processing, serial processing, parallel processing, or the like. In some embodiments, processing individual recipient response data may involve transforming the data, such as by merging some individual recipient response data with other individual recipient response data, adding additional data to certain individual recipient response data, creating new data based on multiple sets of individual recipient response data, and the like.

Automatic group processing of individual recipient response data in various embodiments may involve processing such data wherein all or part of the processing is accomplished autonomously and without guidance from a human. Of course, any suitable criterion or criteria may be utilized as the basis upon which such automatic group processing may be accomplished. For example, in some embodiments, automatically tracked parameters may be utilized, such as time stamps, recipient contact information, and the like. Embodiments also may involve utilizing a user-specified preference to group process the data. For example, a user may specify a preference to group process based on parameters such as recipient information, topic information, word occurrence information, or any other preference capable of being specified by the user, and the data may be automatically group processed based on the user specified parameter.

Various embodiments, such as shown in FIG. 1, may include a group message response data processor module (10) of a group message response content processor (8). Such a module may be a component of the processor dedicated to group processing of automatically reviewed individual recipient response data. Such group processing may be accomplished perhaps as described herein, and such a group message response data processor module (10) in fact may provide for the automated capability for automatically reviewing individual recipient response data in some embodiments.

In some embodiments, automatically group processing said automatically reviewed individual recipient response data may involve ordering the automatically reviewed individual recipient response data. Such ordering may involve selecting an attribute of the data and arranging the data in an order based on the attribute. Examples may include time ordering the data, recipient ordering the data based on the recipient's identity or some other recipient attribute, topic ordering the data, ordering the data based on occurrences of a word or words within the data, or ordering the data based on any other suitable attribute thereof. Accordingly, various embodiments, such as shown in FIG. 1, may include an individual recipient response data ordering module (23) of a group message response content processor (8). Such a module may be a component of the processor dedicated to automatically ordering multiple individual recipient response data. Ordering of such data may be accomplished perhaps as described herein, and such an individual recipient response data ordering module (23) in fact may provide for the automated capability for automatically ordering individual recipient response data in some embodiments. Moreover, the individual recipient response data ordering module (23) may have an ordering subroutine (24) to accomplish ordering individual recipient response data, perhaps as described herein. For example, the ordering subroutine (24) in various embodiments may be a time ordering subroutine, a recipient ordering subroutine, a topic ordering subroutine, a word occurrence ordering subroutine, or the like. Such a subroutine naturally may include hardware, software, or both kinds of components suitable to accomplish such ordering, and may be utilized by other processors and modules described herein as needed.

Some embodiments may include automatically collating multiple individual recipient response data. Such collation may involve combining aspects of or even all of such multiple individual response data to create collated recipient response data information. Whereas prior to collation the multiple recipient response data may have represented several disparate sources of individual recipient response data, the collated recipient response data information may be a single source capturing all desired recipient response data from multiple individual recipients in one element, for example perhaps a data file. Of course, such automatic collation of multiple individual recipient response data may involve collating such data wherein all or part of the collation is accomplished autonomously and without guidance from a human.

Various embodiments, such as shown in FIG. 1, may include an individual recipient response data collation module (17) of a group message response content processor (8). Such a module may be a component of the processor dedicated to automatically collating multiple individual recipient response data. Collation of such data may be accomplished perhaps as described herein, and such an individual recipient response data collation module (17) in fact may provide for the automated capability for automatically collating multiple individual recipient response data in some embodiments.

Naturally, any suitable parameter capable of being automatically executed with respect to such recipient response data may serve as the basis upon which the automatic collation is performed. In some embodiments, automatically tracked parameters may be utilized, such as time stamps, recipient contact information, and the like. Embodiments also may involve utilizing a user-specified preference to automatically collate the data. For example, a user may specify a preference to collate based on parameters such as time information, recipient information, topic information, word occurrence information, or any other preference capable of being specified by the user. In various embodiments, such as shown in FIG. 1, a user may specify a preference to automatically collate data through a user specified collation input (18).

Various embodiments may further include updating such collated recipient response data information. Information may be initially collated, and then additionally collated to include further individual recipient response data as such further individual recipient response data may become available. For example, the first two individual recipient responses to an electronic communication sent by a user to a plurality of individual recipients may be initially collated. As subsequent individual recipients respond to the user's original message, the initially collated data may be updated, for example by collating with each subsequent response. In this manner, the collated recipient response data information may stay current with the most recent individual recipient response. Updating may occur as many times as are needed or desired, and perhaps may be done in real time or near-real time. A data collation update subroutine (19), such as shown in FIG. 1, may be utilized in various embodiments to accomplish such collation. Such a subroutine naturally may include hardware, software, or both kinds of components suitable to accomplish such collation, and may be utilized by other processors and modules described herein as needed.

Moreover, embodiments may involve utilizing a user-specified preference to automatically update collated recipient response data. A user may specify preferences such as utilizing a time-based preference (such as periodically checking whether new data has become available for collation), a recipient information preference (such as collating based on the identity or other attribute of an individual recipient), a topic information preference (such as information content in an individual recipient response relating to a specified topic), a word occurrence preference (such as the occurrences of a specific word or groups of words in an individual recipient response), or any other preference capable of being specified by a user. Accordingly, a data collation update subroutine (19) in various embodiments, such as shown in FIG. 1, may include a user-specified preference input (20) having appropriate preference entries (21), such as a time-based preference entry, a recipient information preference entry, a topic information preference entry, a word occurrence preference entry, or the like. The user-specified preference input (20) may permit the entry of preference information by the user into the data collation update subroutine (19) as described herein, and the preference entries (21) may provide an interface allowing the user to configure the input information as data collation preferences. Such a subroutine naturally may include hardware, software, or both kinds of components suitable to accomplish such sending, and may be utilized by other processors and modules described herein as needed.

Of course, embodiments may involve preserving the original, non-collated individual recipient response data. This information may be utilized and stored as appropriate, for example perhaps by automatically allowing a user to access the original, non-collated individual recipient response data. An original non-collated individual recipient response data preservation subroutine (22) may be utilized in various embodiments, such as shown in FIG. 1, to accomplish such preservation. Such a subroutine naturally may include hardware, software, or both kinds of components suitable to accomplish such preservation, and may be utilized by other processors and modules described herein as needed. Moreover, collated recipient response data information may be maintained and provided in any appropriate format, for example perhaps as an electronic communication perhaps provided to a user.

In various embodiments, automatically group processing at least some automatically reviewed individual recipient response data as described herein may create group processed automatically reviewed individual recipient response data. Such group processed data of course may be further processed in any appropriate or desired manner. For example, some embodiments may include meta-processing the group processed data. Meta-processing may involve using the group processed data to generate additional information about the group processed data. For example, group processed response data may be meta-processed to determine how many responses were received in proportion to the total number of individual recipients to whom a message was sent, how individual recipient response data was processed, descriptive text or keywords associated with the group processed response data, and the like. Moreover, as with other types of processing discussed herein, meta-processing may be accomplished using automatically tracked parameters or perhaps user-specified preferences to supply the criterion or criteria upon which the group processed data is meta-processed. For example, in various embodiments meta-processing may be based on the number of responses, the identity of individual recipients, the format of responses, the content of responses, the location of individual recipients, the contact information for individual recipients, and the like.

Accordingly, various embodiments, such as shown in FIG. 1, may include a grouped response information meta-processor module (25) of a group message response content processor (8). Such a module may be a component of the processor dedicated to the meta-processing of group processed data. Such meta-processing may be accomplished perhaps as described herein, and such a grouped response information meta-processor module (25) in fact may provide for the automated capability for automatically meta-processing group processed data in some embodiments. Moreover, the grouped response information meta-processor module (25) may have various meta-processing subroutines (26) to accomplish the meta-processing of group processed data, perhaps as described herein. For example, meta-processing subroutines (26) in various embodiments may include a response number meta-processing subroutine, an individual recipient identity meta-processing subroutine, a response format meta-processing subroutine, a response content meta-processing subroutine, an individual recipient location meta-processing subroutine, and an individual recipient contact information meta-processing subroutine. Such subroutines naturally may include hardware, software, or both kinds of components suitable to accomplish such meta-processing, and may be utilized by other processors and modules described herein as needed. A grouped response information meta-processor module further may include a user specified preference input (27). Such a user-specified preference input (27) may permit the entry of preference information by the user into the grouped response information meta-processor module (25), perhaps as described herein.

Embodiments, such as shown in FIG. 1, may include automatically providing group processed recipient response data on a communications device (3). For example, in some embodiments the communications device (3) may be the communications device (3) of the user sending the original message, and the group processed recipient response data may be based on individual recipient responses to the user's original message. Providing the group processed recipient response data may be done in any manner executable by the communications device (3). For example, the group processed recipient response data in various embodiments may be provided as a voice message, text message, email, or the like. Accordingly, a source communications device (3) in various embodiments may include a group message response output (28). Such a group message response output (28) may be responsive to a group message response content processor (8), and may automatically provide group processed recipient response data on the source communications device (3). Such data may be provided perhaps as described herein, and such a group message response output (28) in fact may provide for the automated capability for automatically providing group processed recipient response data on a communications device (3) in some embodiments.

Some embodiments may involve utilizing a user-predefined notification. A user may predefine one or more attributes of a notification by which the data is provided. For example, the user may specify notification only of data accrued at specific times, data from specific recipients, data addressing certain topics, data containing a certain word or words, or the like. Any attribute capable of being specified by a user and automatically executed potentially may be utilized as a user-predefined notification. Accordingly, a group message response output (28) in some embodiments, such as shown in FIG. 1, may be at least in part a user-predefined output. Additionally, some embodiments may involve utilizing multiple notification parameters. For example, a user may be notified of more than one attribute of the data being provided. Any combination of attributes capable of being automatically executed potentially may be utilized in multiple notification parameters. Accordingly, a group message response output (28) in some embodiments may be at least in part a multiple notification parameter output.

With further reference to FIGS. 1-3, embodiments may include a dual tone multi-frequency contact identification functionality. Users may access stored contact lists or groups, for example on an automated central hub (1), and select individual contacts using a dual tone multi-frequency enabled communications device (3). The dual tone multi-frequency capability of the communications device (3) may be used to establish a connection and interact, such as with the automated central hub (1), without the need to utilize an access portal (2). For example, in telephony embodiments, including perhaps voice-over-Internet-protocol embodiments, a user may connect to the hub (1) by dialing a telephone number. Using the telephone's keypad to send dual tone multi-frequency signals to the hub (1), the user may access the contact lists and groups stored on the hub (1). Any suitable dual tone multi-frequency implemented protocol may be utilized as appropriate. In some embodiments, such a protocol may involve multiple-parameter entry, such as wherein the automatic central hub (1) may accept more than one input from the user to execute a given function. For example, individual contacts may be identified from a given contacts list or group by punching keypad numbers corresponding not just to letters in the contact's first name or last name, but perhaps both the first and last name. Such multiple parameter entry may serve to increase the effectiveness of the dual tone multi-frequency protocol. Naturally, any number of parameters may be established as may be appropriate for any given functionality. Moreover, once the contact has been identified, additional actions may be taken utilizing the dual tone multi-frequency implemented protocol. For example, the user may be able to select one of several listed telephone numbers for a given contact, for example from a dual tone multi-frequency menu, and initiate a telephone call.

Embodiments may include an authorized access functionality. Communications devices (3) may be selectively authorized to access the various functionalities described herein, for example via an automated central hub (1). For example, in telephony embodiments, including perhaps voice-over-Internet-protocol embodiments, a Web-based interface of an access portal (2) may permit the entry of telephone numbers to be granted authorized access to the functionality of a hub (1). Moreover, embodiments may involve specifying privileges for the authorized telephone numbers, for example to permit access to some functionalities (such as voicemail) but not others (such as group messaging). In this manner, certain communications devices (3) may be given authorizations of varying scope on temporary or permanent bases, which may be useful to accommodate travel schedules, client access, employee turnover, and the like.

Embodiments may include a message screening functionality. Messages may be stored, for example perhaps at an automated central hub (1), with additional information appended or prepended to the message. A user may review the additional information without reviewing the message itself. In this manner, the user may use the additional information to determine if the message itself should be perhaps reviewed or perhaps discarded. The additional information may come from any suitable source. For example, in telephony embodiments, including perhaps voice-over-Internet-protocol embodiments, a caller leaving a message first may be prompted to answer one or more screening questions, for example to provide a name and brief subject for the message. The additional information may appended or prepended to the message, for example by the automated central hub (1). A user later may connect to the hub (1) and review messages, for example using a dual tone multi-frequency protocol to interact with the hub (1). When the message is reviewed, the user may hear the caller's name and subject for the message, and use the information to decide whether to review the message itself. Of course, the screening questions may be any as may be deemed suitable by the user, and perhaps may be specified by using an access portal (2), perhaps as described elsewhere herein. Automated information also may be appended or prepended to the message as well, such as a time stamp, message duration, and the like. Moreover, the message screening functionality may include a capability to automatically return the telephone call of the message, complete the call, and proceed to review the next message saved in the queue, without needing to hang up the call between steps. Additionally, embodiments may permit a user to select one set of screening questions for the messaging system and another set of questions for a communications device (3), perhaps as described elsewhere herein.

Embodiments may include a call out functionality. More particularly, an automated central hub (1) in various embodiments may be connected to alternative networks to the PSTN, such as the Internet, including perhaps a capability to utilize voice-over-Internet-protocols. The automated central hub (1) may include requisite software and hardware capabilities to communicate across such alternative networks. Accordingly, calls routed through the automated central hub (1) may be further routed along such alternative networks. Calls routed in such a manner may avoid charges that accrue on the PSTN, potentially resulting in cost savings to users of the enhanced communications exchange.

Embodiments may involve a general connection functionality. Stock communications devices (3) may be capable of executing various of the enhanced exchange functionalities described herein, for example perhaps by establishing a connection to an automated central hub (1), without requiring modification or additional specialized equipment, such as dedicated connection hardware, on-site hardware, special telephones, or the like. In telephony embodiments, for example, communications devices (3) such as landlines or cell phones may be able to access enhanced exchange functionalities using the PSTN or standard wireless networks. Such connectivity may be independent of the service provider for the telephone and may not require connection through modems or voice-over-Internet-protocol devices. In some embodiments a hub (1) may perform the functions that otherwise would be handled by such service providers, modems, voice-over-Internet-protocol devices, or the like. Accordingly, the functionalities of the hub (1) may be generally available to the communications devices (3), so long as conventional networks are able to connect the communications device (3) to the hub (1). Moreover, this general connection functionality may result in cost savings to users by eliminating the need to purchase costly services or equipment that otherwise might be needed to achieve a private branch exchange functionality. In some embodiments, perhaps no additional equipment at all need be purchased or otherwise obtained. Efficiencies in reducing time, spreading costs, maximizing personnel resources, and the like also may be realized in some embodiments by centrally locating an automated central hub (1) and having multiple users remotely access the hub (1), rather than requiring each user to set up requisite equipment at their respective locations and dedicating personnel resources for the management of such equipment.

Embodiments may involve a concurrent calling functionality. Outgoing telephone calls to multiple telephone numbers may be placed simultaneously. Such simultaneous call placement may be enabled for any stock telephone device, such as a landline, cell phone, or the like, perhaps without the need for specialized equipment or services, such as a modem, voice-over-Internet-protocol device, specialized telephone, order from a service provider, or the like. In some embodiments, dual tone multi-frequency protocols may enable the user to interact with a hub (1) by using the telephone device's keypad. For example, the concurrent calling functionality may be effected by the hardware and software configuration of the automated central hub (1), for example perhaps by using voice-over-Internet-protocol. Accordingly, so long as the telephone device is able to connect to the central hub (1), as perhaps may be accomplished via the general connection functionality perhaps described elsewhere herein, the concurrent calling functionality may be available for stock telephone devices. The concurrent calling functionality perhaps may be useful in conjunction with the multiple communication device connection functionality, group messaging functionality, or perhaps other functionalities described herein.

Embodiments may involve a simplified user interface. Access portals (2) may permit users to configure some or all functionalities of an automated central hub (1), perhaps from one single interface, and perhaps from any remote location so long as a network connection may be established between the access portal (2) and the hub (1). For example, embodiments may involve using a laptop computer to configure a hub (1) in locations such as an office, a home, a hotel room, and the like, for example to update the user's telephone number as the user moves from location to location. In particular, embodiments may provide for a software-driven Web-based interface with capability to fully configure the hub (1)'s settings while presenting a familiar Web-type interface to users. Users may be able to configure some or all of the hub's (2) functionalities such as by text entry, clicking, one-clicking, or the like, perhaps within a single Web page or Website, and perhaps using familiar Web protocols such as drop-down menus, fill-in fields, hot links, and the like. The need to rely on service providers to configure and change functionality settings may be eliminated. By placing control of hub (1) functionality in the hands of users in such a manner, significant cost savings may be realized when compared to conventional systems, which may require perhaps substantial expertise to manage private branch exchange systems, possibly limited to on-site access of such systems, and possibly even restricted to service provider management of such systems.

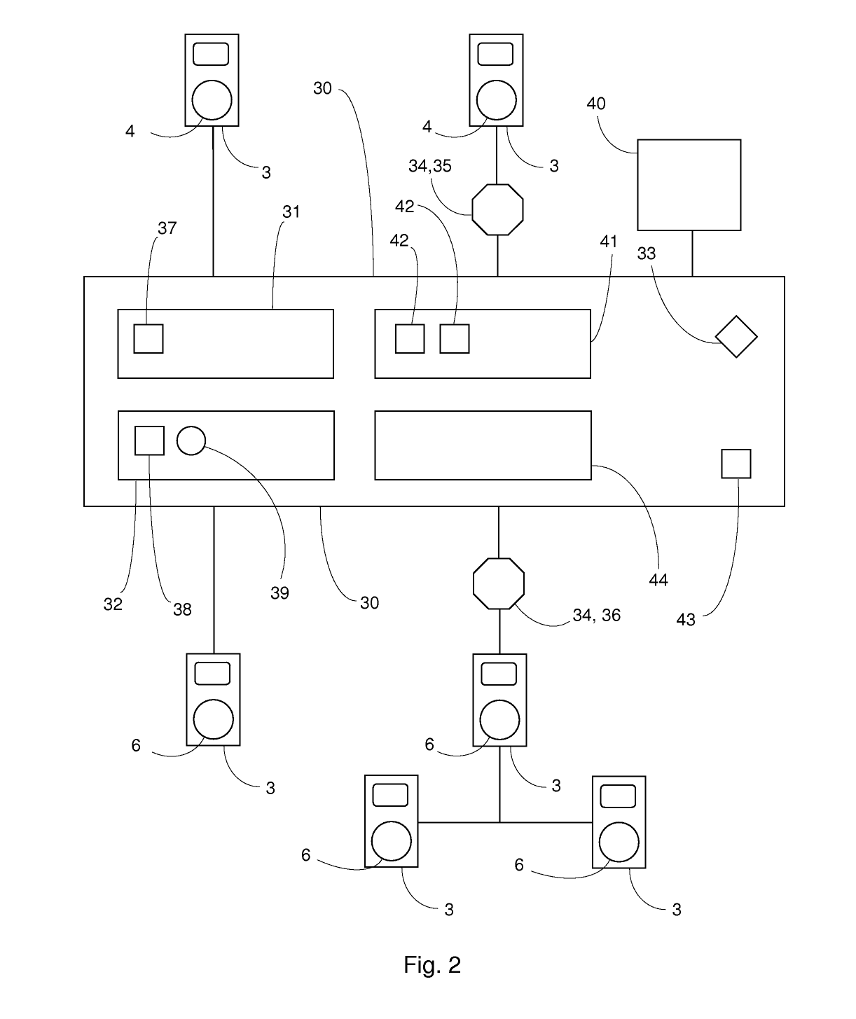

Now with reference to FIG. 2, embodiments may include an incoming electronic communications content processor (30) configured to utilize an incoming electronic communication having at least some relevant electronic origination identification data. An incoming electronic communications content processor (30) may perform data processing of the content of such incoming electronic communications having at least some relevant electronic origination identification data. For example, such data processing may involve transforming some portion or aspect of the content to some degree, such as by actions including sorting content, selecting content, performing an operation on content, running content through an algorithm, or the like. Such data processing of incoming electronic communications having at least some relevant electronic origination identification data may involve creating new information content, perhaps to generate new information value, perhaps as described herein.

Embodiments may involve automatically identifying relevant electronic origination identification data of an electronic communication. Relevant electronic identification data may be electronic data tending to identify some relevant aspect of an electronic communication. For example, relevant electronic origination identification data may be electronic data tending to identify the origin of the electronic communication. Any data tending to identify the origin of an electronic communication in this manner potentially may be utilized as relevant electronic origination identification data. Examples may include ANI information, area code information, local exchange carrier information, long distance carrier information, geographic location information, analog information, digital information, packet switched information, Internet Protocol information, source telephone number information, automated central hub (1) access number information, and the like. Moreover, relevant electronic origination identification data in various embodiments may be part of, may accompany, or otherwise may be associated to an electronic communication as it is transmitted. Moreover, identifying relevant electronic origination identification data may involve analyzing an electronic communication to determine the presence and nature of any relevant electronic origination identification data for the electronic communication, and accomplishing such identification automatically may include accomplishing such identification wherein all or part of the identification is accomplished autonomously and without guidance from a human.

Accordingly, various embodiments, such as shown in FIG. 2, may include a relevant electronic origination identification data processor module (31) of an incoming electronic communications content processor (30). Such a module may be a component of the processor dedicated to the automatic identification of relevant electronic origination identification data of an electronic communication. Such identification may be accomplished perhaps as described herein, and such a relevant electronic origination identification data processor module (31) in fact may provide for the automated capability for identification of relevant electronic origination identification data of an electronic communication in some embodiments. Moreover, the relevant electronic origination identification data processor module (31) may have an identification subroutine (37) to accomplish the automatic identification of relevant electronic origination identification data of an electronic communication, perhaps as described herein. For example, the identification subroutine (37) in various embodiments my be an ANI information identification subroutine, an area code information identification subroutine, a local exchange carrier information identification subroutine, a long distance carrier information identification subroutine, a geographic location information identification subroutine, or the like. Such a subroutine naturally may include hardware, software, or both kinds of components suitable to accomplish such a, and may be utilized by other processors and modules described herein as needed.

Of course, embodiments also may involve automatically identifying relevant electronic destination identification data of an electronic communication. This may be analogous to automatically identifying relevant electronic origination identification data of an electronic communication, with the exception that origination aspects instead may be destination aspects. Embodiments, such as shown in FIG. 2, similarly may include a relevant electronic destination identification data processor module (44). Such a module likewise may be analogous to a relevant electronic origination identification data processor module (31), again with the exception that origination aspects instead may be destination aspects.

Embodiments may involve automatically altering relevant electronic identification data of an electronic communication. The relevant identifying aspects or attributes of such data may be changed, perhaps so that the original identity of the electronic communication no longer can be detected. For example, embodiments may involve automatically altering ANI information, automatically altering area code information, automatically altering local exchange carrier information, automatically altering long distance carrier information, automatically altering geographic location information, automatically altering analog information, automatically altering digital information, automatically altering packet switched information, automatically altering Internet Protocol information, automatically altering source telephone number information, automatically altering automated central hub (1) access number information, and the like.

Accordingly, various embodiments, such as shown in FIG. 2, may include a relevant electronic identification data alteration processor module (32) of an incoming electronic communications content processor (30). Such a module may be a component of the processor dedicated to the automatic alteration of relevant electronic identification data of an electronic communication. Such alteration may be accomplished perhaps as described herein, and such a relevant electronic identification data alteration processor module (32) in fact may provide for the automated capability for alteration of relevant electronic identification data of an electronic communication in some embodiments. Moreover, the relevant electronic identification data alteration processor module (32) may have an alteration subroutine (38) to accomplish the automatic alteration of relevant electronic identification data of an electronic communication, perhaps as described herein. For example, the alteration subroutine (38) in various embodiments may be an ANI information alteration subroutine, an area code information alteration subroutine, a local exchange carrier information alteration subroutine, a long distance carrier information alteration subroutine, a geographic location information alteration subroutine, an analog information alteration subroutine, a digital information alteration subroutine, a packet switched information alteration subroutine, an Internet Protocol information alteration subroutine, a source telephone number information alteration subroutine, an automated central hub access number information alteration subroutine, or the like. Such a subroutine naturally may include hardware, software, or both kinds of components suitable to accomplish such alteration, and may be utilized by other processors and modules described herein as needed.

In some embodiments, relevant electronic origination identification data may be altered to exhibit desired characteristics, such as by removing relevant electronic origination identification data, hiding relevant electronic origination identification data, replacing relevant electronic origination identification data, or the like. Embodiments even may include user specifying particular relevant electronic origination identification data to exhibit for an electronic communication, for example as wherein ANI information for telephone calls originating from extensions within a private branch exchange may be altered to exhibit only the main telephone number for the organization. Of course, accomplishing any alteration automatically may include accomplishing such alteration wherein all or part of the alteration is accomplished autonomously and without guidance from a human. Accordingly, an alteration subroutine (38) in various embodiments may be a relevant electronic origination identification data removal subroutine, a relevant electronic origination identification data concealment subroutine, a relevant electronic origination identification data replacement subroutine, a user specified relevant electronic origination identification data alteration subroutine, or the like.

Moreover, various embodiments may include user specifying data alteration preferences for the relevant electronic identification data. A user may select one or more bases upon which the data is automatically altered. For example, the user may specify certain kinds of information to alter, such as specific area codes, specific geographic locations, specific local exchange carrier information, or the like, and the data may be automatically altered based on the user specified preferences. Any preference capable of user specification and automatic execution may be utilized in user specifying data alteration preferences. Of course, accomplishing any alteration automatically may include accomplishing such alteration wherein all or part of the alteration is accomplished autonomously and without guidance from a human. Accordingly, a relevant electronic identification data alteration processor module (32) in various embodiments, such as shown in FIG. 2, may include a user-specified preference input (39). The user-specified preference input (39) may permit the entry of preference information by the user into the relevant electronic identification data alteration processor module (32), perhaps as described herein.

Some embodiments may involve utilizing relevant electronic origination identification data which has been automatically identified to automatically alter relevant electronic identification data of an electronic communication. Previously identified origination attributes or aspects of the electronic communication may form the basis for subsequent alteration of relevant electronic identification data. For example, embodiments may involve modifying the automatically identified relevant electronic origination identification data, retaining at least a portion of the automatically identified relevant electronic origination identification data, replacing the automatically identified relevant electronic origination identification data, and other alterations involving the automatically identified relevant electronic origination identification data. Accordingly, an alteration subroutine (38) in various embodiments, such as shown in FIG. 2, may be a relevant electronic origination identification data modification subroutine, a relevant electronic origination identification data retention subroutine, a relevant electronic origination identification data replacement subroutine, or the like.

Embodiments may include automatically receiving an incoming electronic communication and automatically transmitting the incoming electronic communication with automatically altered relevant electronic identification data to an outgoing destination. The electronic communication may be incoming from any appropriate source from which it may be automatically received and may be outgoing to any destination to which it may be automatically transmitted. For example, various embodiments may utilize a communications network to automatically receive and automatically transmit electronic communications. Electronic communications may be automatically received from a source communications device (3), perhaps such as a communications device (3) from which the electronic communication may be originated, for example by user entering the electronic communication into a communications device (3). Electronic communications may be automatically transmitted to a destination communications device (3) or even any attached communications devices (3) attached to the destination communications device (3), perhaps such as a communications device (3) where the electronic communication may be terminated, for example by a recipient getting the electronic communication. Naturally, accomplishing any such reception or transmission automatically may include accomplishing such reception and transmission wherein all or part of the reception or transmission is accomplished autonomously and without guidance from a human.

Various embodiments, such as shown in FIG. 2, may include an outgoing electronic communications router (33) responsive to an incoming electronic communications content processor (30). Such a router may serve to automatically transmit electronic communications to outgoing destinations, for example wherein such outgoing electronic communications have automatically altered relevant electronic identification data that has been altered by the incoming electronic communications content processor (30). This transmission may be accomplished perhaps as described herein, and such an outgoing electronic communications router (33) in fact may provide for the automated capability for transmitting the incoming electronic communication with automatically altered relevant electronic identification data to an outgoing destination in some embodiments.

Communications networks in various embodiments may be on-net, off-net, or may include both on-net and off-net elements. In particular, different sections of a communications network may be owned or operated by different entities. For example, varying components of communications network infrastructure may be owned or operated by entities such as local exchange carriers, long distance carriers, wireless service providers, Internet service providers, Internet backbone operators, government entities, and the like. While the terms on-net and off-net as a practical matter may be understood from their customary usage in the art, electronic communications generally may considered on-net when they are routed only through a commonly owned or operated communications network, and generally may be considered off-net when they are routed across communications networks owned and operated by different entities. For example, off-net communications often may incur costs or fees associated for transmitting an electronic communication from one communications network to another, as may happen when an electronic communication is routed among different local exchanges or long distance carriers. By way of comparison, on-net communications typically may not incur costs or fees associated with using off-net communications network elements, such as by keeping the electronic communication entirely within the network of a single owner or operator. Moreover, in some embodiments, the Internet generally may be considered to be an on-net network, while proprietary exchanges of the PSTN, such as local exchanges and long distance lines, generally may be considered to be off-net. In particular, technology differences and business structures may make the cost of routing an electronic communication through the Internet substantially less expensive than through the PSTN, thereby supporting distinguishing the two as on-net and off-net, respectively.

In various embodiments, an electronic communication may at least partially transit an on-net communications network, such as wherein the electronic communication may be routed through all or part of an on-net communications network. Moreover, one or more source or destination communications devices (3) may be off-net in some embodiments. Electronic communications originating at off-net source communications devices (3) or terminating at off-net destination communications devices (3) may be connected to an on-net network in any appropriate manner to at least partially transit the on-net network. For example, embodiments, such as shown in FIG. 2, may involve connecting to the on-net network at a local exchange switch (34), connecting to the on-net network at an automated central hub (1), or connecting to the on-net network using any other modality suitable for making such a connection. The switch (34), hub (1), or other modality may serve to make the connection between the off-net network on one side and the on-net network on the other side, for example by switching, electronic transmission, completion of a circuit, or any other suitable modality. In this manner, embodiments may involve automatically receiving an incoming electronic communication originating from a source local exchange (35) and automatically transmitting it, perhaps with automatically altered relevant electronic identification data, to a destination local exchange (36) separately located from, and perhaps even off-net with respect to, the source local exchange (35).

Of course, automatically altering relevant electronic identification data may affect how an electronic communication is identified as it transits various on-net and off-net sections of a communications network. For example, embodiments, such as shown in FIG. 2, may involve receiving an incoming electronic communication having automatically altered relevant electronic identification data at a destination local exchange switch (36). The destination local exchange switch (36) may identify the electronic communication based on the altered identification data, and not the original identification data. For example, if the electronic communication originated in a different area code, but its identification data was altered to change its area code to that of the destination local exchange (36), the destination local exchange (36) may identify the electronic communication as local to the destination exchange and treat it accordingly. In this manner, relevant electronic identification data of an electronic communication may be altered to affect how the electronic communication is handled by various elements of on-net and off-net communications networks. Examples may include coordinating source relevant electronic identification data and destination relevant electronic identification data, matching source relevant electronic identification data and destination relevant electronic identification data, hiding relevant electronic identification data, removing relevant electronic identification data, user specifying relevant electronic identification data, and any other alteration of relevant electronic identification data capable of being automatically executed. Naturally, such relevant electronic identification data in various embodiments may be relevant electronic origination identification data. Moreover, an alteration subroutine (38) in various embodiments may be a source relevant electronic origination identification data and destination relevant electronic origination identification data coordination subroutine, a source relevant electronic origination identification data and destination relevant electronic origination identification data matching subroutine, a relevant electronic origination identification data concealment subroutine, a relevant electronic origination identification data removal subroutine, a relevant electronic origination identification data replacement subroutine, a user specified relevant electronic origination identification data subroutine, or the like.

Automatically altering relevant electronic identification data in various embodiments may involve utilizing stored identification data. Any suitable identification data which may be useful for accomplishing such alterations may be stored, such as stored telephone number information, stored ANI information, stored area code information, stored local exchange carrier information, stored long distance carrier information, stored geographic location information, and the like. Such identification data may be stored in any suitable manner to allow its use in automatically altering relevant electronic identification data, such as in a stored identification data database (40), perhaps even a centralized database. For example, embodiments, such as shown in FIG. 2, may include a database of stored identification data relating to a set of telephone numbers, for example perhaps certain local exchange or long distance carrier telephone numbers, or perhaps even all U.S. or international telephone numbers.

Examples of utilizing stored identification data in various embodiments may include comparing relevant electronic origination identification data of an incoming electronic communication to the stored identification data, altering an incoming electronic communication based on attributes of the stored identification data, forwarding an incoming electronic communication to attached communications devices (3) listed in the stored identification data, or any other utilization of the stored identification data consistent with the principles discussed herein. Accordingly, various embodiments, such as shown in FIG. 2, may include a stored identification data utilization module (41) of an incoming electronic communications content processor (30). Such a module may be a component of the processor dedicated to utilizing stored identification data. Such utilization may be accomplished perhaps as described herein, and such a stored identification data utilization module (41) in fact may provide for the automated capability to utilize stored identification data in some embodiments. For example, in some embodiments a stored identification data utilization module (41) may be a stored identification data comparison module. Moreover, the stored identification data utilization module (41) may have one or more appropriate utilization subroutines (42), such as an attached communications device forwarding subroutine. Such subroutines naturally may include hardware, software, or both kinds of components suitable to accomplish the utilization of stored identification data, and may be utilized by other processors and modules described herein as needed.

Embodiments may involve tracking, logging, and storing automatically identified relevant electronic origination identification data. Even if altered, as described herein, such data may be preserved as a result being tracked, logged and stored, perhaps in its original form or perhaps in an abbreviated form. Tracking may involve any of various ways to monitor the data and any alterations made thereto, logging may involve creating a record of the data and any alterations made thereto, and storing may involve retaining the data and any alterations made thereto in a format in which the stored data later may be utilized. Of course, such tracking, logging, and storing may be accomplished automatically, wherein the data is tracked, logged, or stored in whole or in part autonomously and without guidance from a human. A relevant electronic origination identification data preservation subroutine (43) may be utilized in various embodiments, such as shown in FIG. 2, to accomplish such preservation. Examples may include a relevant electronic origination identification data tracking subroutine, a relevant electronic origination identification data logging subroutine, a relevant electronic origination identification data storage subroutine, or the like. Such subroutines naturally may include hardware, software, or both kinds of components suitable to accomplish such preservation, and may be utilized by other processors and modules described herein as needed.

In certain embodiments, an automated central hub (1) may include an ANI transfer functionality. The hub (1) may include a centralized database for storage of telephone number data. The stored telephone number data may be utilized in conjunction with an on-net network to which the hub (1) may be connected. Telephone numbers may be for communications devices (3) located in geographically disparate locations, such as perhaps throughout the United Stated or perhaps even internationally. Each of the telephone numbers may be pooled within a group of telephone numbers that make the numbers routable to each other without touching any local networks for a connecting charge. The numbers may be able to connect to each other without switching fees or the like, perhaps making them free to each other for an unlimited amount of time. For example, a 303-area-code number located in Denver and a 213-area-code number located in Los Angeles may be free to each other, since both numbers are located in the database and may be connected through the hub (1) via the on-net network.

The centralized database in such embodiments may be formatted in a structure suitable for holding telephone number data. For example, a table structure may be utilized to hold telephone numbers, for example perhaps various access numbers assigned to individual users, some or all issued U.S. telephone numbers, or perhaps even international telephone numbers. Moreover, the database may include data associating individual access numbers to the telephone numbers of one or more communications devices (3) belonging to such individual users. In this manner, communications routed through the hub (1) to and from access numbers, for example telephone calls, may be connected to any or all of the individual user's communications devices (3) associated with the access number. For example, a 303-area-code access number located in Denver may be associated in the database to a 303-area-code telephone number in Denver for the user's landline, a 720-area-code telephone number in Denver for the user's cell phone, and so forth. Calls placed by third parties to the user's 303-area-code access number may be connected through to the user's landline and cell phone.

Of course, the telephone number data stored in these embodiments on the centralized database may include the ANI information for the numbers. In this manner, when the hub (1) connects calls between telephone numbers, the hub (1) may be able to determine ANI information for each connected number, for example such as to what local exchange each connected number belongs, whether the numbers reside on different exchanges, whether the numbers are serviced by different long-distance carriers, the geographic location of the numbers, and the like. The ANI transfer functionality of the hub (1) may include an ability of the hub (1) to change some or all ANI information of one or more numbers being connected to match some or all ANI information of one or more numbers being connected to. This may be accomplished by any suitable hardware or software configuration of the hub (1). For example, call data received by the hub (1) may be in the form of a packet switching protocol over a non-PSTN network, and hub (1) software may be able to identify packet data corresponding to the ANI and substitute, modify, or otherwise change the ANI information as desired.

Using an automated central hub (1) in these embodiments may provide an ability to keep all communications routed through the hub (1), such as telephone calls, as a local calling plan. For example, a caller may use his communications device (3), such as a telephone, to call the access number for the hub (1). When connected to the hub (1), the caller may enter a long distance number to call. The hub (1) may utilize the centralized database to compare the long distance number to areas of coverage. The calling number may be logged by the hub (1), and the hub (1) may change the ANI of the calling number to the area code of the telephone number stored in the database as the long distance number and then call the long distance number. From an outside perspective, the call with the transferred ANI may appear to be a local call from the local application telephone number. From the hub (1) perspective, the hub (1) may see the actual telephone number and track the ANI change to the local area telephone number and long distance telephone number in its call record. By the using this technique, the call may be on-net and may not accrue any switching or long distance fees to perhaps any telephone number, whether it is known to the hub (1) or not.

Accordingly, such embodiments may permit connection between on-net access numbers and off-net telephone numbers that mimic on-net characteristics. In particular, some or all long-distance fees may be avoided, because when the call is routed from the hub (1) to the switch of the destination local exchange, the ANI information of the calling number may have been changed to match the ANI information for the local exchange. As a result, the switch at the local exchange may interpret the calling number as a local number, and avoid assessing long-distance fees. In this manner, the emphasis of an inbound call identification being transferred to a local access number may be to allow a long-distance number to call an off-net telephone number and make the call look like a local call. This switch of ANI information may let any access number on the hub (1) group message all connecting numbers of off-net telephones without leaving the network, and may allow any telephone to connect to one or multiple telephone numbers that are stored in the database for reduced or perhaps no fees. The transfer of the ANI of the calling number to that of a local number may transfer the call to a tier of telephone numbers which become the local calling area. For example, without the benefit of the ANI transfer functionality, a telephone call from a 303-area-code on-net access number in Denver to a 213-area-code off-net telephone number in Los Angeles typically otherwise would be a long-distance call. However, changing the ANI information of the 303-area-code number to match the ANI information of the 213-area-code number using the ANI transfer functionality of the hub (1) may effectively make the call an on-net call, thereby perhaps incurring no long-distance charges.

Naturally, all examples discussed throughout the text herein are for illustrative purposes only, and should not be construed to limit the disclosure of the inventive technology herein to only the specific examples discussed.

As can be easily understood from the foregoing, the basic concepts of the present invention may be embodied in a variety of ways. It involves both electronic communications exchange techniques as well as devices to accomplish the appropriate electronic communications exchange. In this application, the electronic communications exchange techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “processor” should be understood to encompass disclosure of the act of “processing”—whether explicitly discussed or not—and, conversely, were there effectively disclosure of the act of “processing”, such a disclosure should be understood to encompass disclosure of a “processor” and even a “means for processing” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### I. U.S. Patent Documents

| DOCUMENT NO. | PUB'N DATE | PATENTEE OR |
|---|---|---|
| & KIND CODE (if known) | mm/dd/yyyy | APPLICANT NAME |
| 2002/0099534 | 07/25/2002 | Hegarty |
| 2003/0046073 | 03/06/2003 | Mori et al. |
| 2004/0267574 A1 | 12/30/2004 | Stefanchik et al. |
| 2004/0307074 A1 | 02/12/2004 | Stefanchik et al. |
| 2004/0365713 A1 | 08/26/2004 | Leighton |
| 2006/0215638 A1 | 09/28/2006 | Abe |
| 5,581,612 | 12/03/1996 | Nishikawa |
| 5,689,585 | 11/18/1997 | Bloomberg et al. |
| 5,704,371 | 01/06/1998 | Shepard |
| 5,715,299 | 02/03/1998 | Mosley et al. |
| 5,822,544 | 10/13/1998 | Chaco et al. |
| 6,026,363 | 02/15/2000 | Shepard |
| 6,131,032 | 10/10/2000 | Patel |
| 6,172,948 B1 | 01/09/2001 | Keller et al. |
| 6,215,784 B1 | 04/10/2001 | Petras et al. |
| 6,272,461 B1 | 08/07/2001 | Meredith et al. |
| 6,272,575 B1 | 08/07/2001 | Rajchel |
| 6,362,409 B1 | 03/26/2002 | Gadre |
| 6,405,195 B1 | 06/11//2002 | Ahlberg |
| 6,556,973 B1 | 04/29/2003 | Lewin |
| 6,611,846 B1 | 08/26/2003 | Stoodley |
| 6,615,350 B1 | 09/02/2003 | Schell et al. |
| 6,681,119 B1 | 01/20/2004 | Verdonk |
| 6,766,328 B1 | 07/20/2004 | Stefanchik et al. |
| 6,829,580 B1 | 12/07/2004 | Jones |
| 7,133,583 B2 | 09/26/2006 | Mitsuo |
| 7,203,300 B2 | 04/10/2007 | Shaffer et al. |
| 7,411,965 | 08/12/2008 | Chu et al. |
| 7,412,042 | 08/12/2008 | Henry |
| 7,412,050 | 08/12/2008 | Renner et al. |
| 7,416,700 | 08/26/2008 | Buechler et al. |
| 7,418,095 | 08/26/2008 | Knott et al. |
| 7,418,472 | 08/26/2008 | Shoemaker et al. |
| 7,422,862 | 09/09/2008 | Reed et al. |
| 7,423,009 | 09/09/2008 | Nakagawa et al. |
| 7,425,978 | 09/16/2008 | Katz |
| 7,426,264 | 09/16/2008 | Henderson |
| 7,430,187 | 09/30/2008 | Holt et al. |
| 7,430,190 | 09/30/2008 | Luo et al. |
| 7,430,554 | 09/30/2008 | Heisinger, Jr. |
| 7,433,457 | 10/07/2008 | Marwell et al. |
| 7,433,855 | 10/07/2008 | Gavan et al. |
| 7,435,592 | 10/14/2008 | Har-Noy |
| 7,436,948 | 10/14/2008 | Thenthiruperai |
| 7,437,141 | 10/14/2008 | Mason et al. |
| 7,437,313 | 10/14/2008 | Mussman |
| 7,437,328 | 10/14/2008 | Graves et al. |
| 7,439,050 | 10/21/2008 | Pompejus et al. |
| 7,440,442 | 10/21/2008 | Grabelsky et al. |
| 7,440,555 | 10/21/2008 | Breitenbach et al. |
| 7,440,558 | 10/21/2008 | Heilmann et al. |
| 7,440,562 | 10/21/2008 | Barnes et al. |
| 7,443,963 | 10/28/2008 | Scherer |
| 7,443,972 | 10/28/2008 | Barlow et al. |
| 7,443,974 | 10/28/2008 | Bedingfield |
| 7,444,171 | 10/28/2008 | Gruchala et al. |
| 7,444,287 | 10/28/2008 | Claudatos et al. |
| 7,444,383 | 10/28/2008 | Horvitz |
| 7,446,906 | 11/04/2008 | Bloomfield |
| 7,447,159 | 11/04/2008 | Croak et al. |
| 7,447,195 | 11/04/2008 | Chan et al. |
| 7,447,209 | 11/04/2008 | Jeffay, et al. |
| 7,447,217 | 11/04/2008 | Knaebschen |
| 7,447,301 | 11/04/2008 | Crockett et al. |
| 7,447,780 | 11/04/2008 | McMahon et al. |
| 7,450,567 | 11/11/2008 | Mamnani |
| 7,450,573 | 11/11/2008 | Kamenetsky et al. |
| 7,450,702 | 11/11/2008 | Solin |
| 7,450,930 | 11/11/2008 | Williams et al. |
| 7,451,921 | 11/18/2008 | Dowling et al. |
| 7,453,803 | 11/18/2008 | Bugenhagen |
| 7,453,809 | 11/18/2008 | Savoor et al. |
| 7,453,830 | 11/18/2008 | Dezonno et al. |
| 7,454,000 | 11/18/2008 | Henderson |
| 7,454,164 | 11/18/2008 | Goss |
| 7,454,505 | 11/18/2008 | Kallner et al. |
| 7,457,249 | 11/25/2008 | Baldwin et al. |
| 7,457,254 | 11/25/2008 | Boutboul |
| 7,457,265 | 11/25/2008 | Julka et al. |
| 7,457,279 | 11/25/2008 | Scott et al. |
| 7,457,280 | 11/25/2008 | Lindquist et al. |
| 7,457,284 | 11/25/2008 | Gerszberg et al. |
| 7,457,399 | 11/25/2008 | Onken et al. |
| 7,457,402 | 11/25/2008 | Sbisa et al. |
| 7,457,754 | 11/25/2008 | McIntosh |
| 7,457,823 | 11/25/2008 | Shraim et al. |
| 7,458,075 | 11/25/2008 | Keys |
| 7,460,496 | 12/02/2008 | Miloslavsky et al. |
| 7,460,520 | 12/02/2008 | Cody et al. |
| 7,460,652 | 12/02/2008 | Chang |
| 7,460,653 | 12/02/2008 | Brahm et al. |
| 7,460,654 | 12/02/2008 | Jenkins et al. |
| 7,460,658 | 12/02/2008 | Watts et al. |
| 7,460,660 | 12/02/2008 | Ono et al. |
| 7,461,126 | 12/02/2008 | Berkeland et al. |
| 7,461,174 | 12/02/2008 | Chan et al. |
| 7,461,381 | 12/02/2008 | Adams et al. |
| 7,463,730 | 12/09/2008 | Katkam et al. |
| 7,466,695 | 12/16/2008 | Gerszberg et al. |
| 7,466,710 | 12/16/2008 | Clemm et al. |
| 7,466,805 | 12/16/2008 | Timmins et al. |
| 7,467,135 | 12/16/2008 | Coker et al. |
| 7,467,198 | 12/16/2008 | Goodman et al. |
| 7,468,992 | 12/23/2008 | Leblanc et al. |
| 7,469,046 | 12/23/2008 | Jackson et al. |
| 7,469,047 | 12/23/2008 | Judkins et al. |
| 7,469,142 | 12/23/2008 | Nelakanti et al. |
| 7,469,384 | 12/23/2008 | Thompson et al. |
| 7,470,797 | 12/30/2008 | Salvati et al. |
| 7,471,648 | 12/30/2008 | Andersen et al. |
| 7,471,785 | 12/30/2008 | Tsuruhara |
| 7,472,129 | 12/30/2008 | Adya et al. |
| 7,472,134 | 12/30/2008 | Kaku |
| 7,472,142 | 12/30/2008 | Prahlad et al. |
| 7,472,159 | 12/30/2008 | Freimuth et al. |
| 7,472,162 | 12/30/2008 | Thompson et al. |
| 7,472,168 | 12/30/2008 | Allan |
| 7,472,184 | 12/30/2008 | Creamer et al. |
| 7,472,195 | 12/30/2008 | Burckart et al. |
| 7,472,202 | 12/30/2008 | Parupudi et al. |
| 7,472,238 | 12/30/2008 | Gokhale et al. |
| 7,472,254 | 12/30/2008 | Collins |
| 7,472,273 | 12/30/2008 | Haverinen |
| 7,472,290 | 12/30/2008 | Diab et al. |
| 7,472,338 | 12/30/2008 | Caro |
| 7,472,342 | 12/30/2009 | Haut et al. |
| 7,472,352 | 12/30/2008 | Liversidge et al. |
| 7,472,395 | 12/30/2008 | Miller et al. |
| 7,472,421 | 12/30/2008 | Cummins |
| 7,472,422 | 12/30/2008 | Agbabian |
| 7,474,432 | 01/06/2009 | Kirchhoff et al. |
| 7,474,617 | 01/06/2009 | Molen et al. |
| 7,474,633 | 01/06/2009 | Halbraich et al. |
| 7,474,634 | 01/06/2009 | Webster et al. |
| 7,474,650 | 01/06/2009 | O'Neill |
| 7,474,657 | 01/06/2009 | Sahni et al. |
| 7,474,741 | 01/06/2009 | Brunson et al. |
| 7,474,750 | 01/06/2009 | Lekatsas et al. |
| 7,474,795 | 01/06/2009 | Sirohey et al. |
| 7,475,000 | 01/06/2009 | Cook et al. |
| 7,475,013 | 01/06/2009 | Rifkin |
| 7,475,019 | 01/06/2009 | Rosenfeld et al. |
| 7,475,021 | 01/06/2009 | Wilbrink et al. |
| 7,475,058 | 01/06/2009 | Kakivaya et al. |
| 7,475,060 | 01/06/2009 | Toyama et al. |
| 7,475,061 | 01/06/2009 | Bargeron et al. |
| 7,475,091 | 01/06/2009 | McCauley et al. |
| 7,475,093 | 01/06/2009 | Tomic et al. |
| 7,475,098 | 01/06/2009 | Patterson et al. |
| 7,475,106 | 01/06/2009 | Agnoli et al. |
| 7,475,107 | 01/06/2009 | Maconi et al. |
| 7,475,124 | 01/06/2009 | Jiang et al. |
| 7,475,136 | 01/06/2009 | Sinn |
| 7,475,139 | 01/06/2009 | Goodman et al. |
| 7,475,151 | 01/06/2009 | Delany et al. |
| 7,475,200 | 01/06/2009 | Melvin |
| 7,475,201 | 01/06/2009 | Melvin |
| 7,475,274 | 01/06/2009 | Davidson |
| 7,475,284 | 01/06/2009 | Koike |
| 7,475,303 | 01/06/2009 | Edgar et al. |
| 7,475,340 | 01/06/2009 | Bodin et al. |
| 7,475,387 | 01/06/2009 | Chandane |
| 7,475,426 | 01/06/2009 | Copeland III et al. |
| 7,475,427 | 01/06/2009 | Palliyil et al. |
| 7,475,428 | 01/06/2009 | Smith, Fred H. et al. |
| 7,475,432 | 01/06/2009 | Carpentier et al. |

### II. Foreign Patent Documents

| Foreign Patent Document | | |
|---|---|---|
| Country Code, Number, | PUB'N DATE | PATENTEE OR |
| Kind Code (if known) | Mm/dd/yyyy | APPLICANT NAME |
| WO06084258A2 | 08/10/2006 | Verbal World, Inc. |
| WO02046886 | 06/13/2002 | Verbal World, Inc. |

### III. Non-Patent Literature Documents

International Application Number PCT/US2007/01242, filed Jan. 17, 2007, entitled
Methods and Apparatus for Manipulation of Primary Audio-Optical Data Content and
Associated Secondary Data Content, 123 pages and 6 drawings
US National Phase Application Number 11/815,437; filed Aug. 02, 2007, entitled System
for the Management and Use of Information From Voice Input; 63 pages and 2
drawings
US Provisional Application Number 61/027,303, filed Feb. 08, 2008, entitled Methods
And Apparatus For Enhanced Private Branch Exchange Functionality; 20 pages and 33
drawings
US Provisional Application Number 61/050,953, filed May 06, 2008 date entitled
Methods and Apparatus for Processing Conferenced Data, 19 pages and 22 drawings
Provisional Application number 61/050,960, filed on May 06, 2008, entitled Methods and
Apparatus for Network Identification of Telephony Data, 12 pages and 2 drawings
Admiral Online DictoMail Voicemail to Text Messaging, printed webpages Jan. 31, 2006, 4 pages
Admiral Online DictoMail Voicemail to Text Translation Technology, Press Release
Newswire, Feb. 02, 2005
ID3, WikiPedia, wikipedia.org/wiki/Id3#column-one; 9 pages, downloaded Feb. 23, 2006
Metaphor Solutions Speech IVR Home Page, printed webpages Jan. 31, 2006, 2 pages
metaphorsol.com/company/index.htm; Metaphor Solutions Company Description; 1 page
metaphorsol.com/solutions/customer_service_applications; 2 pages
metaphorsol.com/solutions/customer_service_demo.htm; Metaphor Solutions Live
Speech Applications; 5 pages
metaphorsol.com/solutions/enterprise.htm; Metaphor Solutions Enterprise Speech
Applications; 2 pages
metaphorsol.com/solutions/FAQ.htm; Metaphor Solutions Frequently Asked Questions; 5 pages
metaphorsol.com/solutions/financial.htm; Financial Services Speech Applications; 2 pages
metaphorsol.com/solutions/healthcare.htm; Metaphor Solutions Health Care Speech
Applications; 2 pages
metaphorsol.com/solutions/retail.htm; Metaphor Retail Speech Applications; 2 pages
metaphorsol.com/solutions/speechoutlook.htm; Metaphor Solutions SpeechOutlook; 8 pages
metaphorsol.com; Metaphor Solutions Speech IVR Home Page; 2 pages
RIFF, WikiPedia, wikipedia.org/wiki/RIFF#column-one; 3 pages, downloaded Feb. 23, 2006
spinvox.com/article.php?id=35; Setting up SpinVox - FAQs; 3 pages
spinvox.com/news/index.php; SpinVox - Latest SpinVox Updates; 5 pages
spinvox.com/services/business.php; Business Users; 2 pages
spinvox.com/services/features.php; What Can SpinVox Do?; 2 pages
spinvox.com/services/index.php; Services; 2 pages
spinvox.com; Converting Voicemail to Mobile Phone Texts - Free Trial; 2 pages
spinvox.com; SpinVox - Services; 4 pages
The Sonic Spot, Wave File Format, sonicspot.com/index.html, Home: Guides: File
Formats: Specifications: Wave File Format, 11 pages, downloaded Feb. 23, 2006
http://www.meetingbywire.com/ConferenceServers.htm; What is a Conference Server?
Article, 3 pages
http://www.cisco.com/en/US/products/sw/ps5664/ps5669/products_tech_note09186a00
802; Meeting Place Server Disaster Recovery Procedure for Networked conference
Server; 5 pages
http://www.ibiblio.org/gferg/ldp/Conference-Server-HOWTO.html; A Conference
BNU/Linux Server, Frank Martin; 10 pages
http://www.cs.columbia.edu/irt/cinema/doc/sipconf.html; SIP Audio Conference Server; 3 pages
http://www.nch.com.au/conference/; Telephone Conference Server Download; Quorum
Telephone Conference Server; 2 pages
http://www.wiredred.com/web-conference/; Web Conference Software, Video
Conference, and Online Meeting Collaboration; 4 pages
http://www.onebox.com/lp/virtual-office-assistant.asp?sourceid=102100&s_; Virtual
Office Assistant, One Box, One Number, One Solution; 1 page.
http://www.businessphonesolutions.com/?gclid=CMmV5cGLgpgCFRo-
awodpzOMww; AccessLine SmartOFFICE; 1 page
http://home.evoicereceptionist.com/s/r/evr_search?source_id=31001&source %20=ppc
&gcli . . . ; eVoice Receptionist, Professional sound for your business - anywhere,
anytime; 1 page
http://www.packet8.net/; Packet 8 VoIP Internet Phone Service Provider and Voice
Over IP Telephony; 1 page
http://portal.acm.org/citation.cfm?id=63266.63290; The Design of an Automated
Assistant for Acquiring Strategic Knowledge; 3 pages
http://social.microsoft.com/forums/en-US/speechserverauthoring/thread; Ability to set
ANI on Transfer (VXML); Authoring, Speech Server, Microsoft Forums; 2 pages
http://developer.voicegenie.com/reference.php?ref=variablesdetails; VoiceGenie
Developer Workshop, Voice XML Reference; 8 pages

Thus, the applicant(s) should be understood to have support to claim and make a statement of invention to at least: i) each of the electronic communications exchange devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be revisited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-10. (canceled)

11. An electronic communications exchange system comprising:
at least one source communications device;
a user input of said at least one source communications device having a group message entry;
an incoming electronic communications content processor responsive to said group message entry configured to utilize an incoming electronic communication having at least some relevant electronic origination identification data;
a relevant electronic origination identification data processor module of said incoming electronic communications content processor;
a relevant electronic identification data alteration processor module of said incoming electronic communications content processor;
an outgoing electronic communications router responsive to said incoming electronic communication content processor;
at least part of an on-net network connected to said outgoing electronic communications router;
a local exchange switch connected to said on-net network and an off-net network;
a plurality of recipient communications devices connected to said off-net network;
a recipient input of at least one individual recipient communications device of said plurality of recipient communications devices having a group message response entry;
a group message response content processor responsive to at least one said group message response entry;
an individual recipient response data review module of said group message response content processor;
a group message response data processor module of said group message response content processor;
a group message response output of said source communications device responsive to said group message response content processor.

12. An electronic communications exchange system as described in claim 11 further comprising an electronic communication entered into said user input of said at least one source communications device having a group message entry selected from the group consisting of:
a voice communication;
a text communication;
an email communication;
a text-to-voice communication;
a voice-to-text communication;
an analog communication;
a digital communication;
a packet-switched communication;
an Internet Protocol communication.

13. An electronic communications exchange system as described in claim 11 wherein each said communications device comprises a communications device selected from the group consisting of:
a telephone;
a landline;
a cell phone;
a smart phone;
a personal digital assistant;
a VoIP device;
a computer;
a desktop;
a laptop.

14. An electronic communications exchange system as described in claim 11 wherein said group message response content processor further comprises an individual recipient response data collation module.

15. An electronic communications exchange system as described in claim 11 wherein said group message response content processor further comprises an individual recipient response data ordering module.

16. An electronic communications exchange system as described in claim 11 wherein said group message response content processor further comprises a grouped response information meta-processor module.

17. An electronic communications exchange system as described in claim 11 wherein said at least part of an on-net network further comprises a communications network selected from the group consisting of:
at least some portion of a PSTN;
at least some portion of a data network;
at least some portion of the Internet;
at least some portion of a VoIP network;
at least some portion of a wireless network.

18. An electronic communications exchange system as described in claim 11 wherein said relevant electronic identification data alteration processor module of said incoming electronic communications content processor comprises a subroutine selected from the group consisting of:
an ANI information alteration subroutine;
an area code information alteration subroutine;
a local exchange carrier information alteration subroutine;
a long distance carrier information alteration subroutine;
a geographic location information alteration subroutine.

19. An electronic communications exchange system as described in claim 11 wherein said relevant electronic identification data alteration processor module of said incoming electronic communications content processor comprises a subroutine selected from the group consisting of:
an analog information alteration subroutine;
a digital information alteration subroutine;
a packet switched information alteration subroutine;
an Internet Protocol information alteration subroutine;
a source telephone number information alteration subroutine;
an automated central hub access number information alteration subroutine.

20. An electronic communications exchange system as described in claim 11 wherein said relevant electronic identification data alteration processor module of said incoming electronic communications content processor comprises a subroutine selected from the group consisting of:
a source relevant electronic origination identification data and destination relevant electronic origination identification data coordination subroutine;
a source relevant electronic origination identification data and destination relevant electronic origination identification data matching subroutine;
a user specified relevant electronic origination identification data subroutine;
a relevant electronic origination identification data concealment subroutine;
a relevant electronic origination identification data removal subroutine.

21-55. (canceled)

56. An electronic communications exchange system comprising:
at least one source communications device;
a user input of said at least one source communications device having a group message entry;
a plurality of recipient communications devices;
a recipient input of at least one individual recipient communications device of said plurality of recipient communications devices having a group message response entry;
a group message response content processor responsive to at least one said group message response entry;
an individual recipient response data review module of said group message response content processor;
a group message response data processor module of said group message response content processor.

57-60. (canceled)

61. An electronic communications exchange system as described in claim 56 further comprising a recipient response detection subroutine responsive to said at least one source communications device.

62-64. (canceled)

65. An electronic communications exchange system as described in claim 56 wherein said recipient input having a group message response entry comprises a recipient input having a multiple parameter group message response entry.

66-75. (canceled)

76. An electronic communications exchange system as described in claim 56 wherein said group message response content processor further comprises an individual recipient response data ordering module.

77. An electronic communications exchange system as described in claim 76 wherein said individual recipient response data ordering module comprises an individual recipient response data ordering module having a subroutine selected from the group consisting of:
an individual recipient response data time ordering subroutine;
an individual recipient response data recipient ordering subroutine;
an individual recipient response data topic ordering subroutine;
an individual recipient response data word occurrence ordering subroutine.

78. An electronic communications exchange system as described in claim 56 wherein said group message response content processor further comprises a grouped response information meta-processor module.

79. An electronic communications exchange system as described in claim 78 wherein said grouped response information meta-processor module comprises a subroutine selected from the group consisting of:
a response number meta-processing subroutine;
an individual recipient identity meta-processing subroutine;
a response format meta-processing subroutine;
a response content meta-processing subroutine;
an individual recipient location meta-processing subroutine;
an individual recipient contact information meta-processing subroutine.

80. An electronic communications exchange system as described in claim 78 wherein said grouped response information meta-processor module further comprises a user-specified preference input.

81. An electronic communications exchange system as described in claim 56 wherein said group message response content processor further comprises a user-specified preference input.

82. An electronic communications exchange system as described in claim 56 wherein:
said group message response content processor responsive to at least one said group message response entry;
said individual recipient response data review module of said group message response content processor;
said group message response data processor module of said group message response content processor;
comprise an automated central hub.

83-90. (canceled)

91. A method for exchanging electronic communications comprising the steps of:
automatically receiving an incoming electronic communication;
automatically identifying relevant electronic origination identification data of said incoming electronic communication;
automatically altering relevant electronic identification data of said incoming electronic communication utilizing said automatically identified relevant electronic origination identification data;
automatically transmitting said incoming electronic communication having said automatically altered relevant electronic identification data to an outgoing destination.

92-121. (canceled)

122. An electronic communications exchange system comprising:
an incoming electronic communications content processor configured to utilize an incoming electronic communication having at least some relevant electronic origination identification data;
a relevant electronic origination identification data processor module of said incoming electronic communications content processor;
a relevant electronic identification data alteration processor module of said incoming electronic communications content processor;
an outgoing electronic communications router responsive to said incoming electronic communication content processor.

123-139. (canceled)

140. An electronic communications exchange system as described in claim 122 wherein said relevant electronic identification data alteration processor module of said incoming electronic communications content processor further comprises a user specified preference input.

141-154. (canceled)
